(19) United States
(12) Patent Application Publication
(10) Pub. No.: US 2023/0088007 A1
(43) Pub. Date: Mar. 23, 2023

(54) Combined Display System for Use in a Vehicle

(71) Applicant: Bayerische Motoren Werke Aktiengesellschaft, Muenchen (DE)

(72) Inventors: Andre HARTWIG, Ottobrunn (DE); Mark RIEBE, Kranzberg (DE)

(21) Appl. No.: 17/796,300

(22) PCT Filed: Sep. 16, 2020
(86) PCT No.: PCT/EP2020/075900

§ 371 Date: Jul. 29, 2022

(30) Foreign Application Priority Data
Mar. 19, 2020 (DE) 10 2020 107 644.4

(51) Int. Cl. G02B 27/01; B60K 37/02

(52) U.S. Cl. CPC G02B 27/0101; B60K 37/02; G02B 2027/013; G02B 2027/014; G02B 2027/0141; B60K 2370/1526; B60K 2370/1529; B60K 2370/167; B60K 2370/166; B60K 2370/52; B60K 2370/816

(57) ABSTRACT

A combined display system includes a plurality of displays which are each configured to generate a partial beam of a combined projection light beam having an associated partial display content, the display surfaces of which are adjacent to one another and offset with respect to one another in the beam propagation direction and/or have different spatial orientations; and a combiner screen which is continuously contiguous, is reflective on the user side and preferably transparent on the rear, and is mountable or mounted in the beam path of the combined projection light beam in the vehicle in front of the windscreen such that behind the latter, a virtual image is generated, which is displayed in the user's field of view and is composed of the partial display contents of the plurality of displays.

### BACKGROUND AND SUMMARY OF THE INVENTION

The invention generally relates to a display system for use in a vehicle, which can in particular be a motor vehicle or else any arbitrary other land, air, or water vehicle. The display system is designed to show a virtual image in the field of view of a user, who is a driver or another occupant of the vehicle, via reflection of a projection light beam having a desired display content on a combiner screen arranged in front of a windshield of the vehicle. The invention also relates to a vehicle equipped with such a display system, which can be designed in particular as a single-track vehicle.

Field of view display systems of the above type are known in particular under the name combiner head-up display (CHUD). In a motor vehicle, a desired display content, such as a specification of a speed limit or other useful navigation and vehicle operating instructions, can thus be shown in the field of view of the driver in the form of a virtual image floating above an engine hood, for example, so that said driver can read these display contents without turning his view entirely away from the road and without having to refocus his eyes on a display indicator arranged significantly closer in the cockpit of the vehicle, such as that of an instrument cluster. For this purpose, a CHUD in a classic construction comprises a projection unit housed in the dashboard of a vehicle, which generates a projection light beam having desired display content and desired imaging properties and guides it onto the combiner screen, from which it is reflected to the driver. A limited solid angle range can typically be covered using a classic CHUD, which is suitable, for example, for display contents similar to an instrument cluster in a motor vehicle and results in a virtual image of a comparable size.

Furthermore, field of view display systems or head-up displays (HUDS) are also known for use in vehicles, in which a virtual image is projected into the field of view of an occupant via reflection of a projection light beam directly on the windshield, i.e. without an additional combiner screen. Such HUDs are proposed, among other things, for augmented reality applications or for displaying entertainment content, which require an expanded solid angle range to display the virtual image. However, the influence of a curvature specific to the vehicle design and of other properties of the windshield on the projection light beam reflected thereon is also to be taken into consideration here.

In new cockpit concepts for vehicles, in particular for motor vehicles, attempts are being made more and more frequently to generate a large continuous display surface in which various types of information for the driver or another occupant, which are conventionally distributed, for example, onto the instrument cluster, the CID (central information display), an infotainment display, and/or an outside mirror replacement display, can be integrated.

To implement such a combined display, for example, integrating a flat display screen having a correspondingly large-dimensioned continuous display area in the cockpit of a motor vehicle is known. However, integration of additional or larger conventional flat display screens can greatly change the sense of space in the cockpit, in particular constrict it, or provide a cockpit landscape which has a jagged appearance. Moreover, with this solution the observation distance is relatively small and also cannot be readily increased due to predetermined restrictions by way of the respective vehicle geometry, such as the distance of the dashboard to the front seats.

Alternatively, solution approaches are therefore known in which a large-area section of a windshield is used for the above-mentioned HUD to be able to display various types of information in the virtual image in the view of a vehicle occupant through the windshield in a correspondingly large solid angle range. The integration of such an HUD in the vehicle presumes specific geometric relationships in the cockpit in relation to the windshield, however, so that the required optical function and integration in the vehicle can be ensured. This can be difficult in particular in single-track vehicle concepts, which generally have significantly different geometric conditions than conventional motor vehicles. For example, such an HUD display system would not be integratable in a typical single-track vehicle, the windshield of which is significantly flatter in the vertical direction in comparison to a conventional motor vehicle, i.e. is inclined more strongly in relation to the horizontal, and is curved strongly laterally, i.e. in the horizontal direction.

It is the object of the present invention to specify an alternative display system and/or a display system improved with regard to the above-mentioned problems and goals for a vehicle for showing a virtual image in the field of view of the driver or another occupant, which is suitable in particular for single-track vehicles. It is also the object of the invention to specify a vehicle equipped therewith.

This object is achieved by a combined display system and a vehicle equipped therewith according to the claimed invention.

According to a first aspect, a combined display system for use in a vehicle is provided, which is designed to show a virtual image in the field of view of a user, who can be a driver or another occupant of the vehicle. The vehicle can in particular be a motor vehicle or else any arbitrary other land, air, or water vehicle.

The combined display system of the type described herein comprises multiple displays, which are each designed to generate a partial beam of a composite projection light beam and the display areas of which are arranged adjacent to one another in an operationally ready state of the combined display system and are aligned offset in relation to one another and/or spatially differently with respect to a mean beam propagation direction of the projection light beam. Each of these displays is designed to generate an associated partial display content, which is transported by the respective partial beam, to be displayed to the user as part of a composite virtual image. The mentioned displays can fundamentally be designed in any way suitable for this purpose, and the display areas thereof can be, but do not have to be, planar surfaces.

Furthermore, the combined display system of the type described herein comprises a continuously coherent, in particular integrally formed, combiner screen, which is reflective on the user side for the projection light used and is at least partially transparent in the visible spectrum on the rear side. The combiner screen is, in a state of the combined display system installed in the vehicle, attachable or attached in the beam path of the composite projection light beam between the multiple displays and a windshield of the vehicle in such a way that behind it a virtual image shown in the field of view of the user is generated, which is composed of the partial display contents of the multiple displays displayed adjacent to one another with or without overlap. The combined display system can therefore be designed with respect to the basic structure in particular as a combiner head-up display (CHUD). In an embodiment of the combiner screen which is transparent on the rear side, the virtual image generated by the combined display system can be overlaid on real surroundings observed by the user through the windshield of the vehicle located behind it.

One concept of the present combined display system consists in the arrangement of multiple displays, which are independent of one another and can therefore be spatially positioned and activated differently, in relation to a common, continuously coherent combiner screen in the cockpit region of a vehicle. In this way, in particular the display of an almost continuous floating combined display made up of different partial display contents is enabled for the driver or another occupant of the vehicle, without constricting his sense of space in the cockpit or impairing his perception of the vehicle surroundings.

Different partial display contents can be integrated in this combined display, which are conventionally distributed, for example, onto the instrument cluster, the CID (central information display), diverse infotainment displays, and/or inside and outside mirror replacement displays. Due to the use of displays separate from one another, for example, the quality, resolution, contrast, and other requirements for the respective partial display content can be optimized in a particularly simple and deliberate manner by the individual design and activation of the relevant display. In particular, there is the possibility here of selecting the individual displays from an already known, existing or available display assortment or display kit with respect to the size and the aspect ratio, instead of requiring a large display in a special, unconventional stretch format.

Due to the use of a combiner screen conceived separately for this purpose, the present combined display system is independent in principle from a specific vehicle geometry, in particular from the vehicle-specific windshield shape, and can also be scaled in a simple manner depending on the requirements of the application. For example, a length and curvature of the combiner screen in the vehicle transverse direction suitable for the desired combined display can be freely selected or optimized. Planar display surfaces of the individual displays can be used here, for example, as image sources of the respective partial display contents, which are not arranged in one plane but rather each is aligned optimally for itself on the associated partial beam. An arrangement thus results, for example, in which the location of the multiple displays follows the curvature of the combiner screen.

In particular, the combiner screen can be formed here as a curved screen having curvature parameters which vary steadily in its surface, i.e. continuously and without jumps, or are even constant. In other words, in this embodiment the combiner screen is formed without edges and folds in its user-side reflective surface. This can contribute to an integration of the combiner screen in the vehicle in front of the windshield which appears natural with respect to the cockpit design, and is even inconspicuous in a translucent embodiment. Moreover, it can also be favorable for the display of the display contents in that the combined display has a natural and/or uniform appearance for the user, in particular also from various viewing directions, in particular without conspicuous breaks in the optical display of the overall virtual image. Furthermore, a transition-free fusion of the partial display contents of the individual displays with one another in the virtual image is thus also possible. Not least, such a combiner screen can also be particularly simple and cost-effective to produce.

In particular in the combined display system of the type described herein, at least some of the multiple displays can be positioned or positionable in display distances different from one another from the combiner screen, in order to display the associated partial display contents in the virtual image in predetermined projection distances different from one another from the combiner screen. The mentioned display distances are measured here in the direction of the respective partial beam.

In one specific embodiment, the combiner screen can be curved around a vertical plane which, in a combined display system installed in the vehicle, is parallel to its vertical axis, and in particular can also be formed symmetrically with respect to this vertical plane.

To show different partial display contents mentioned further above via the coherent combiner screen in the field of view of a vehicle driver or another occupant in a naturally and comfortably perceptible manner, including also, for example, partial display contents used as a side mirror replacement, in its horizontal extension direction the combiner screen can cover a viewing angle of at least 30°, preferably at least 60°, particularly preferably at least 90° from a spatial region (eye box) predetermined for user eyes. (Terms used here and also at other points to describe the present combined display system, which is designed for use in a vehicle, such as “below this”, “above this”, “vertical”, “horizontal”, “longitudinal”, “transverse”, and the like, can always be understood as based on or in relation to the typical vehicle coordinates.)

Alternatively or additionally, the combiner screen can have an essentially constant radius of curvature in its horizontal extension direction, which can in particular approximately correspond to a mean distance of the user from the combiner screen. The distance of the user and above all his viewing angle on the combiner screen can thus remain approximately equal for central and for lateral partial display contents, i.e. for various viewing directions.

Alternatively or additionally, the multiple displays can be an odd number of displays, in particular three displays, of which a central display (i.e. its display surface) is arranged opposite to a central section of the combiner screen in the middle in the horizontal extension direction and in particular is aligned symmetrically with respect to the mentioned vertical plane and the remaining displays are lateral displays, the display surfaces of which are arranged on both sides of the central display opposite to lateral sections of the combiner screen, into which the middle central section merges in the horizontal extension direction, and are aligned approximately along these lateral sections, for example in each case symmetrically in pairs with respect to the mentioned vertical plane.

The combined display system can furthermore comprise a control unit for activating the multiple displays and for providing the display contents to be displayed, wherein
the central display and the control unit are designed and configured, via the central display and the central section of the combiner screen, to show a partial display content in the field of view of the user, which comprises predetermined static and/or dynamic items of information, in particular about a current vehicle system or movement state and/or about an upcoming route section, for assisting the vehicle operation, for navigation, and/or for entertaining the user; and/or
the lateral displays and the control unit are designed and configured to show partial display contents in the field of view of the user via the lateral displays and the lateral sections of the combiner screen, which are capable of replacing a view into a left or right side mirror (mirror replacement system), for example in that they are based in a way known per se on the signal of one or more monitoring cameras for monitoring the lateral and rear vehicle surroundings.

According to a further aspect, a vehicle is provided, in particular a motor vehicle or any arbitrary other land, air, or water vehicle. The vehicle comprises a windshield, a dashboard arranged below it, and a vehicle seat arranged in front of it. Furthermore, the vehicle comprises a combined display system of the type described herein, the multiple displays of which are arranged in the dashboard and the combiner screen of which is arranged in the beam path of the composite projection light beam generated by the multiple displays in front of the windshield in such a way that a virtual image is shown in the field of view of a vehicle occupant, in particular a driver, when he looks through the combiner screen and windshield.

In particular, the combined display system, i.e. both the combiner screen and the entirety of the multiple displays, in particular the above-mentioned central display, can be formed, arranged, and aligned symmetrically around a vertical vehicle longitudinal plane going centrally through the vehicle seat of the occupant or the driver.

According to one embodiment, the mentioned vehicle is designed as a single-track vehicle (also known under the name “single-track car”), in which the combined display system is in particular arranged and aligned symmetrically around a vertical vehicle longitudinal plane extending centrally in the vehicle.

In one refinement of this embodiment, the windshield is delimited in each case by an A-pillar on both sides in the vehicle transverse direction, and the combiner screen extends in front of the windshield essentially over its entire width in the vehicle transverse direction, in particular from the one A-pillar to the other A-pillar or over an entire horizontal angle range delimited by the A-pillars, which is seen from a spatial region (eye box) predetermined for the eyes of the driver.

Terms used herein to describe the combined display system, which is designed for use in a vehicle, such as “below this”, “above this”, “vertical”, “horizontal”, “longitudinal”, “transverse”, and the like, can always be understood as based on or in relation to the typical vehicle coordinates.

The above aspects of the invention and their embodiments and specific designs are explained in more detail hereinafter on the basis of an example illustrated in the appended drawings. The drawings are solely schematic; they are in particular not to be read as true to scale. Identical reference signs stand for elements which are identical or correspond to one another in their function therein.

### BRIEF DESCRIPTION OF THE DRAWINGS

FIG. 1 shows a schematic side view of a combined display system of the type described herein in a single-track vehicle to show a virtual image in the field of view of a driver, whose average eye position is indicated.

FIG. 2 shows a perspective front view of the combined display system according to FIG. 1 from the interior of the single-track vehicle diagonally from above.

### DETAILED DESCRIPTION OF THE DRAWINGS

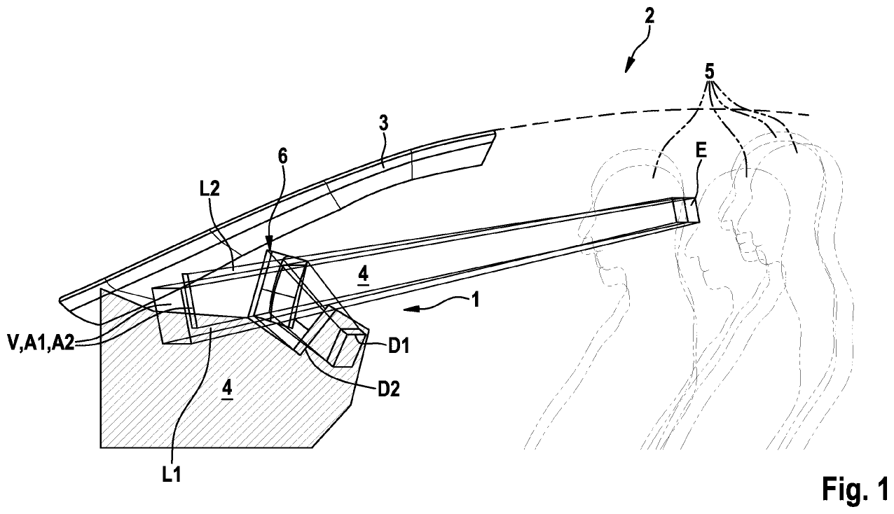

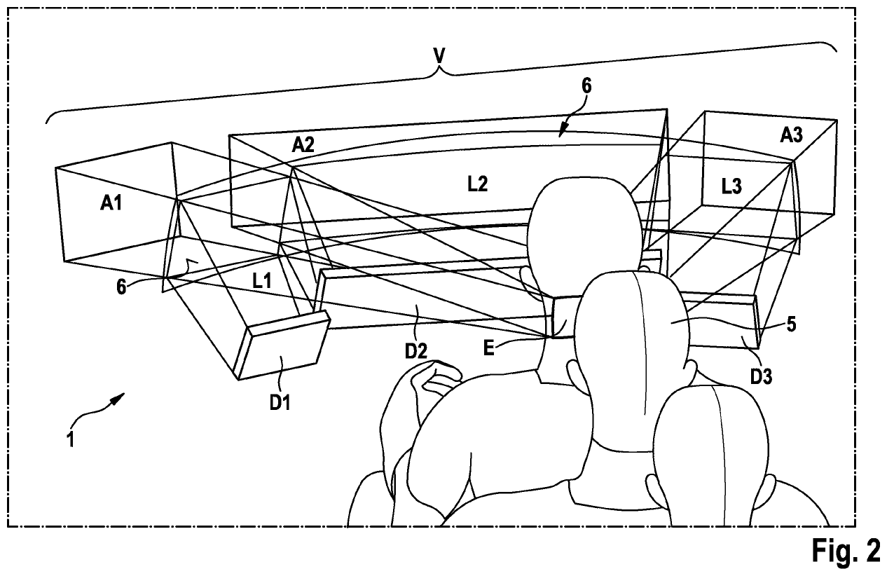

All different embodiments, variants, and specific design features of the combined display system and the vehicle according to the above aspects of the invention which are mentioned further above in the description and in the following claims can be implemented in the example shown in FIGS. 1 and 2. They are therefore not all repeated once again hereinafter. This also applies accordingly to the term definitions and effects already indicated further above with respect to individual features, which are shown in FIG. 1 and FIG. 2.

FIG. 1 shows a simplified schematic side view of an example of a combined display system 1 of the type described herein, which is installed in this example in the cockpit region of a single-track vehicle 2, of which only a windshield 3 and a dashboard 4 arranged underneath it are indicated in FIG. 1. In this example, the single-track vehicle 2 is a motor vehicle, and the combined display system 1 is designed to show a virtual display image V in the field of view of a user, in this case a driver 5, when he looks through the windshield 3. An average eye position E of the driver 5 is also schematically indicated and is located within an eye box of the combined display system 1, which can be adaptable, for example, in a way known per se manually or via eye tracking to a present position of the driver 5 in the single-track vehicle 2.

The combined display system 1 comprises multiple, in this example three, displays D1, D2, and D3 (cf. FIG. 2) integrated in the dashboard 4, which in operation each generate a partial beam L1, L2, and L3 of a composite projection light beam L having an associated partial display content A1, A2, and A3, and the display surfaces of which, which are planar solely by way of example, are arranged adjacent to one another and offset in relation to one another and spatially aligned differently in the beam propagation direction. In the side view of FIG. 1, only two of the displays D1-D3 can be seen, while the mutual arrangement of the displays D1, D2, and D3 and the associated partial beams L1, L2, and L3 can be inferred from a perspective front view according to FIG. 2.

Furthermore, the combined display system 1 comprises a continuously coherent, in this example integrally formed, combiner screen 6 which is reflective on the user side and transparent on the rear side and which is attached in the beam path of the composite projection light beam L in the single-track vehicle 2 in front of its windshield 3 in such a way that when the driver looks through the windshield 3, a virtual image V is shown in his field of view, which is composed of the partial display contents A1, A2, and A3 of the displays D1, D2, and D3.

FIG. 2 shows a perspective front view of the combined display system according to FIG. 1 from the interior of the single-track vehicle 2 diagonally from above. As can be seen particularly well in FIG. 2, in this example the display, i.e. the virtual image V, is divided into three parts. A central large display, which comprises the partial display content A2 generated by the central display D2, is used to display items of driver information or entertainment content. This central display is supplemented in FIG. 2 on the left and right by a further display in each case, which comprise partial display contents A1 and A3 generated by the lateral displays D1 and D3, respectively. This lateral display region is designed in this example, among other things, for displaying a CMS display (camera monitoring system) of an outside mirror replacement system, for example a camera image of a left/right outside mirror of the single-track vehicle 2. The mentioned displays are virtual partial images of the composite virtual image V, which are generated by reflecting the displays D1-D3 integrated in the dashboard 4 into the combiner screen 6.

The combiner screen 6 is embodied here as a curved surface having a radius which approximately corresponds to the distance to the driver position. The distance of the driver from the combiner screen 6 and above all the viewing angle on the combiner screen 6 thus remain constant for the central and the lateral displays.

As shown in FIGS. 1 and 2, the three displays D1, D2, and D3, which are used as the image source, are not arranged in one plane but rather each is aligned optimally for itself on the visible beam, i.e. the respective partial beam L1, L2, or L3. An arrangement thus results in which the location of the displays D1, D2, and D3 follows the curvature of the combiner screen 6.

The arrangement having three individual displays D1, D2, and D3 also provides the option here of influencing the projection distance of the individual display regions, in which the respective partial display contents A1, A2, and A3 are shown, independently of one another. In the illustrated example, this was used to differentiate the outer (outside mirror) displays from the central infotainment display and display them at a greater distance.

The quality, the resolution, the contrast, etc. for the respective partial display contents A1, A2, and A3 can be individually optimized here by the three separate displays D1, D2, and D3. There is also the possibility of selecting the individual displays D1, D2, and D3 according to options from an existing display kit with respect to their size and aspect ratio, instead of requiring a single large display in a special stretch format.

The combined display system 1 proposed herein is suitable in particular for single-track vehicles, in which, as in the single-track vehicle 2 shown according in FIG. 1, for example, an integration of an HUD based on windshield reflection of the type mentioned at the outset would not be possible due to an extremely flatly horizontally extending windshield 3, in which the location of an imaging display would have to travel extremely far forward, for example. The combined display system 1 shown in FIGS. 1 and 2 can just as well also be used in a conventional motor vehicle having multiple front seats, however, in that it is arranged symmetrically, for example, around a vehicle seat of the respective user, such as a driver or front passenger.

### LIST OF REFERENCE SIGNS

1 combined display system
2 single-track vehicle
3 windshield
4 dashboard
5 driver
6 combiner screen
E average eye position of the driver
D1, D2, D3 multiple displays
A1, A2, A3 partial display content of the respective display
L1, L2, L3 partial beam of the respective display
L projection light beam composed of the partial beams
V virtual display image

1.-10. (canceled)

11. A combined display system for a vehicle to show a virtual image in a field of view of a user, the combined display system comprising:
a plurality of displays, each of which is configured to generate a partial beam of a composite projection light beam having an associated partial display content, and display surfaces of which are arranged adjacent to one another and offset in relation to one another and/or spatially aligned differently in a beam propagation direction; and
a continuously coherent combiner screen, which is reflective on a user side, and which is attachable or is attached in a beam path of the composite projection light beam in the vehicle in front of a windshield such that a virtual image shown in the field of view of the user, which is composed of the partial display contents of the duality of displays, is generated behind the combiner screen.

12. The combined display system according to claim 11, wherein the combiner screen is integrally formed.

13. The combined display system according to claim 11, wherein the combiner screen is transparent on a rear side.

14. The combined display system according to claim 11, wherein the combiner screen is curved having curvature parameters which are steady in a surface.

15. The combined display system according to claim 14, wherein the curvature parameters are constant.

16. The combined display system according to claim 11, wherein at least some of the plurality of displays are positioned or positionable at display distances different from one another from the combiner screen, which are measured in a direction of the respective partial beam, to show the associated partial display contents in the virtual image in predetermined projection distances different from one another from the combiner screen.

17. The combined display system according to claim 11, wherein:
the combiner screen is curved around a vertical plane, and
the combiner screen, in a horizontal extension direction perpendicular thereto, covers a viewing angle of at least 30° from a spatial region predetermined for user eyes.

18. The combined display system according to claim 17, wherein the combiner screen is curved symmetrically around the vertical plane.

19. The combined display system according to claim 11, wherein:
the combiner screen is curved around a vertical plane, and
the combiner screen, in a horizontal extension direction perpendicular to the vertical plane, has a constant radius of curvature.

20. The combined display system according to claim 19, wherein the radius of curvature approximately corresponds to a mean user distance from the combiner screen.

21. The combined display system according to claim 19, wherein the combiner screen is curved symmetrically around the vertical plane.

22. The combined display system according to claim 11, wherein:
the combiner screen is curved around a vertical plane and extends in a horizontal extension direction perpendicular to the vertical plane,
the plurality of displaces are an odd number of displays, of which:
a central display is arranged opposite to a central section of the combiner screen in a middle in the horizontal extension direction and is aligned symmetrically with respect to the vertical plane, and
the remaining displays are lateral displays, which are arranged on both sides of the central display opposite to lateral sections of the combiner screen, into which the central section merges in the horizontal extension direction, and are aligned approximately along the horizontal extension direction, in each case symmetrically in pairs with respect to the vertical plane.

23. The combined display system according to claim 22, wherein the combiner screen is curved symmetrically around the vertical plane.

24. The combined display system according to claim 22, further comprising a control unit for activating the duality of displays and for providing display contents to be displayed, wherein:
the central display and the control unit are configured to show a partial display content in the field of the view of the user via the central display and the central section of the combiner screen, which comprises predetermined static and/or dynamic items of information about a current vehicle system or movement state and/or about an upcoming route section, for assisting the vehicle operation, for navigation, and/or for entertaining the user; and/or
the lateral displays and the control unit are configured to show partial display contents, which replace a view into a left or right side mirror of the vehicle, in the field of view of the user via the lateral displays and the lateral sections of the combiner screen.

25. A vehicle comprising:
a windshield;
a dashboard arranged underneath the windshield;
a vehicle seat arranged in front of the dashboard; and
a combined display system according to claim 11, wherein:
the plurality of displays are arranged in the dashboard, and
the combiner screen is arranged in the beam path of the composite projection light beam generated by the plurality of displays in front of the windshield such that the virtual image is shown in the field of the user when the user looks through the combiner screen and the windshield.

26. The vehicle according to claim 25, wherein the combined display system is arranged and aligned symmetrically around a vertical vehicle longitudinal plane going centrally through a vehicle seat of the user.

27. The vehicle according to claim 25, wherein the vehicle is configured as a single-track vehicle in which the combined display system is arranged and aligned symmetrically around a vertical vehicle longitudinal plane extending in the middle in the vehicle.

28. The vehicle according to claim 27, wherein:
the windshield is delimited by an A-pillar on both sides in a vehicle transverse direction; and
the combiner screen extends in front of the windshield over an entire width in the vehicle transverse direction, from one A-pillar to the other A-pillar or over an entire horizontal angle range delimited by the A-pillars, which is seen from a spatial region predetermined for eyes of the user.
